(19) United States
(12) Patent Application Publication
(10) Pub. No.: US 2021/0400306 A1
(43) Pub. Date: Dec. 23, 2021

(54) CODING UNIT PARTITIONING METHOD, IMAGE CODING/DECODING METHOD AND APPARATUSES THEREOF

(71) Applicant: FUJITSU LIMITED, Kawasaki-shi (JP)

(72) Inventors: Luhang XU, Beijing (CN); Jianqing ZHU, Beijing (CN)

(73) Assignee: FUJITSU LIMITED, Kawasaki-shi (JP)

(21) Appl. No.: 17/323,359

(22) Filed: May 18, 2021

(30) Foreign Application Priority Data
Jun. 18, 2020 (CN) 202010559936.3

(51) Int. Cl. H04N 19/66; H04N 19/186; H04N 19/426; H04N 19/169

(52) U.S. Cl. CPC H04N 19/66; H04N 19/1883; H04N 19/426; H04N 19/186

(57) ABSTRACT

Embodiments of this disclosure provide a coding unit partitioning method, image coding/decoding method and apparatuses thereof. The coding unit partitioning method is by performing down-sampling on a processing unit to be partitioned to obtain a block to be partitioned of a predetermined size; inputting a first vector transformed from the block to be partitioned into a trained neural network model to acquire an output result of the trained neural network model. The output result is a partition probability in a horizontal direction and a partition probability in a vertical direction. The method includes performing a horizontal partition on the processing unit to be partitioned when the partition probability in a horizontal direction is greater than or equal to a threshold, and performing a vertical partition on the processing unit to be partitioned when the partition probability in a vertical direction is greater than or equal to the threshold.

### CROSS-REFERENCE TO RELATED APPLICATIONS

This application claims priority under 35 USC 119 to Chinese patent application no. 202010559936.3, filed on Jun. 18, 2020, in the China National Intellectual Property Administration, the entire contents of which are incorporated herein by reference.

### TECHNICAL FIELD

This disclosure relates to the field of image processing.

### BACKGROUND

Versatile Video Coding (VVC) is a new standardization project established by the Joint Video Experts Team (JVET) to improve compression efficiency compare to high efficiency video coding (HEVC). VVC surpass HEVC about 25% coding efficiency in the All Intra (AI) configuration with the increment 10× encoding time.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY OF THE DISCLOSURE

In VVC, a coding unit partition structure more complex than HEVC is used, in which two kinds of binary-tree (BT) partitions and two kinds of ternary tree (TT) partitions (the binary-tree and ternary tree are collectively referred to as a multi-type tree, MTT) are added on the basis of HEVC quad-tree (QT) partition. FIGS. 1A and 1B are schematic diagrams of the two kinds of binary-tree partitions, which are binary-tree partition in a vertical direction and binary-tree tree partition in a horizontal direction. FIGS. 2A and 2B are schematic diagrams of the two kinds of ternary tree partitions, which are ternary tree partition in a vertical direction and ternary tree partition in a horizontal direction. In coding, an image will be partitioned into a series of coding tree units (CTUs); and for each CTU, quad-tree tree partition will be performed first, then MTT partition is independently or identically performed on the quad-tree partitioned units, nodes obtained after partitioning being referred to as coding units (CU); and in image decoding, prediction and transform, etc., may be performed in units of CUs. In addition, each CTU contains a luma component and a chroma component, and identical or different partition structures may be used for each luma component and chroma component.

It was found by the inventors that in an existing method, for units after quad-tree partition, various feasible partition structures are sequentially traversed, rate-distortion function values to which coding results correspond under different partition structures are calculated, and a partition structure to which an optimal coding performance corresponds is selected therefrom according to the rate-distortion function values, which undoubtedly increases the complexity of coding unit partitioning and increases the coding time.

Addressed to at least one of the above problems, embodiments of this disclosure provide a coding unit partitioning method, image coding/decoding method and apparatuses thereof.

According to a first aspect of the embodiments of this disclosure, there is provided a coding unit partitioning apparatus, wherein the apparatus includes: a sampling module configured to perform down-sampling on a processing unit to be partitioned to obtain a block to be partitioned of a predetermined size; an acquiring module configured to input a first vector transformed from the block to be partitioned into a trained neural network model to acquire an output result of the neural network model, the output result including a partition probability in a horizontal direction and a partition probability in a vertical direction; and a determining module configured to perform horizontal partition on the processing unit to be partitioned when the partition probability in a horizontal direction is greater than or equal to a threshold, and perform vertical partition on the processing unit to be partitioned when the partition probability in a vertical direction is greater than or equal to the threshold.

According to a second aspect of the embodiments of this disclosure, there is provided an image coding/decoding apparatus, wherein the apparatus includes: a partitioning module, the coding unit partitioning apparatus as described in the first aspect and a coding/decoding module, the partitioning module being configured to partition an image into a plurality of processing units to be partitioned, the coding unit partitioning apparatus being configured to, for each processing unit to be partitioned, perform down-sampling on the processing unit to be partitioned to obtain a block to be partitioned of a predetermined size, input a first vector transformed from the block to be partitioned into a trained neural network model to acquire an output result of the neural network model, the output result including a partition probability in a horizontal direction and a partition probability in a vertical direction, perform horizontal partition on the processing unit to be partitioned when the partition probability in a horizontal direction is greater than or equal to a threshold, and perform vertical partition on the processing unit to be partitioned when the partition probability in a vertical direction is greater than or equal to the threshold, to obtain coding units, and the coding/decoding module being configured to perform coding and/or decoding by taking a coding unit obtained by partitioning as a unit.

According to a third aspect of the embodiments of this disclosure, there is provided a coding unit partitioning method, wherein the method includes: performing down-sampling on a processing unit to be partitioned to obtain a block to be partitioned of a predetermined size; inputting a first vector transformed from the block to be partitioned into a trained neural network model to acquire an output result of the neural network model, the output result including a partition probability in a horizontal direction and a partition probability in a vertical direction; and performing horizontal partition on the processing unit to be partitioned when the partition probability in a horizontal direction is greater than or equal to a threshold, and performing vertical partition on the processing unit to be partitioned when the partition probability in a vertical direction is greater than or equal to the threshold.

An advantage of the embodiments of this disclosure exists in that down-sampling is performed on the processing unit to be partitioned, hence, a neural network may be used to determine a horizontal direction partition probability and a vertical direction partition probability, and the probabilities are compared with the threshold so as to determine a mode of partitioning the processing unit to be partitioned, thereby improving a coding speed, and ensuring coding efficiency.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1A is schematic diagram of the binary-tree vertical partition of an embodiment of this disclosure;

FIG. 1B is a schematic diagram of the binary-tree horizontal partition of the embodiment of this disclosure;

FIG. 2A is schematic diagram of the ternary tree vertical partition of the embodiment of this disclosure;

FIG. 2B is a schematic diagram of the ternary tree horizontal partition of the embodiment of this disclosure;

FIG. 3 is a schematic diagram of the coding unit partitioning apparatus of an embodiment of this disclosure;

FIG. 4 is a schematic diagram of a structure of a neural network model of the embodiment of this disclosure;

FIG. 5 is a schematic diagram of the image coding/decoding apparatus of an embodiment of this disclosure;

FIG. 6 is a schematic diagram of the coding unit partitioning method of an embodiment of this disclosure;

FIG. 7 is a schematic diagram of the image coding/decoding method of an embodiment of this disclosure; and

FIG. 8 is a schematic diagram of an electronic device of an embodiment of this disclosure.

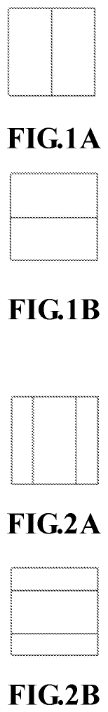

### DETAILED DESCRIPTION OF THE DISCLOSURE

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

These and further aspects and features of this disclosure will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the terms of the appended claims.

### Embodiment of a First Aspect

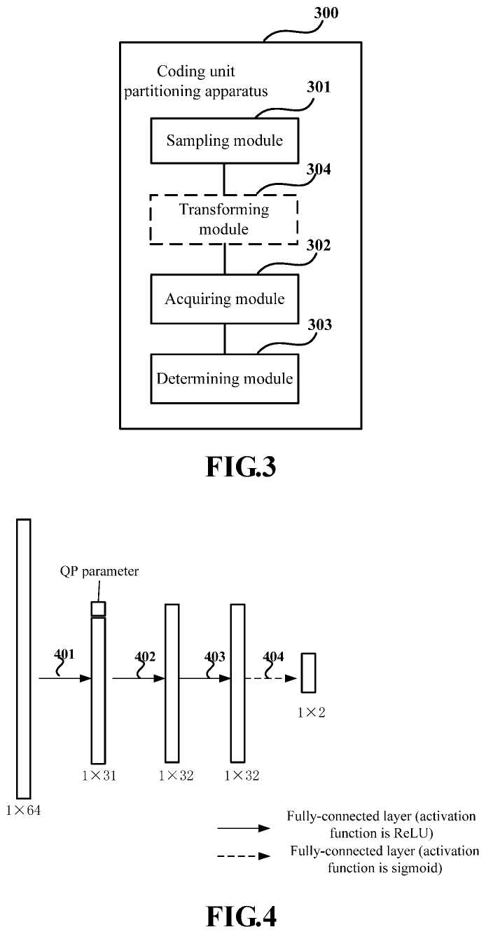

The embodiment of this disclosure provides a coding unit partitioning apparatus. FIG. 3 is a schematic diagram of the coding unit partitioning apparatus of the embodiment of this disclosure. As shown in FIG. 3, a coding unit partitioning apparatus 300 includes:

a sampling module 301 configured to perform down-sampling on a processing unit to be partitioned to obtain a block to be partitioned of a predetermined size;

an acquiring module 302 configured to input a first vector transformed from the block to be partitioned into a trained neural network model to acquire an output result of the neural network model, the output result including a partition probability in a horizontal direction and a partition probability in a vertical direction; and

a determining module 303 configured to perform horizontal partition on the processing unit to be partitioned when the partition probability in a horizontal direction is greater than or equal to a threshold, and perform vertical partition on the processing unit to be partitioned when the partition probability in a vertical direction is greater than or equal to the threshold.

In the embodiment of this disclosure, down-sampling is performed on the processing unit to be partitioned, hence, a neural network may be used to determine a horizontal direction partition probability and a vertical direction partition probability, and the probabilities are compared with the threshold so as to determine a mode of partitioning the processing unit to be partitioned, thereby improving a coding speed, and ensuring coding efficiency.

In some embodiments, an input video stream is composed of multiple consecutive frame images, and each frame image may be partitioned into multiple CTUs in advance. For a three-channel image frame, a CTU contains M×M (M is greater than 0) luma blocks and two corresponding chroma blocks, and sizes of the CTUs are identical. In VVC, for a YUV sequence of a 4:2:0 format, a size of a CTU is 128×128, which means that it contains a luma CTU of a size of 128×128 and two chroma CTUs of a size of 64×64.

In some embodiments, the processing unit to be partitioned may be the CTU, or subunit obtained after binary-tree or ternary tree or quad-tree partition is performed on the CTU, or subunit obtained after two times or more than two times of binary-tree and/or ternary tree and/or quad-tree partition is performed on the CTU, and this embodiment is not limited thereto. A size of the processing unit to be partitioned is less than or equal to 32×32 and greater than or equal to 8×8. For example, the size of the processing unit to be partitioned may be 8×8, 8×16, 16×8, 8×32, 32×8, 16×16, 16×32, 32×16, and 32×32, etc., which shall not enumerated herein any further.

In some embodiments, sizes of an input vector and output vector of the neural network model are relatively fixed. As the size of the processing unit to be partitioned is diverse, in order to be able to determine the partition probabilities in a horizontal direction and a vertical direction by using the neural network model, the sampling module 301 first performs down-sampling on the processing unit to be partitioned to obtain the block to be partitioned of a predetermined size, so that the size of the processing unit to be partitioned is sampled into the block of the same size.

In some embodiments, the sampling module 301 performs down-sampling by using an average pooling method. A window size used for the average pooling may be [W/8, H/8]; where, W is a width of the processing unit to be partitioned, and H is a height of the processing unit to be partitioned. The sampling module 301 partitions the processing unit to be partitioned into a plurality of blocks of the above window size, calculates an average value of values of pixels in each block and takes the average value as a down-sampling value of the window. After the down-sampling, the size of the block to be partitioned of the predetermined size is 8×8.

In some embodiments, as the CTU includes a luma CTU and a chroma CTU, that is, the processing unit to be partitioned also include a luma processing unit and a chroma processing unit, the sampling module 301 performs down-sampling on the luma processing unit and the chroma processing unit respectively. As coding unit partition modes of chroma components Cb and Cr are identical, when down-sampling is performed on the chroma processing unit, down-sampling may only be performed on the chrominance Cb processing unit; however, this embodiment is not limited thereto.

In this embodiment, the apparatus 300 further includes:

a transforming module 304 (optional) configured to transform the block to be partitioned into the first vector;

wherein the transforming module 304 calculates an average value of values of pixels in each block to be partitioned, and subtracts a value of each pixel in the block to be partitioned by the average value to obtain the first vector.

In some embodiments, for example, the block to be partitioned may be expressed as

$$\vert \begin{matrix}{a}_{11} & … & {a}_{18} \\ … & … & … \\ {a}_{81} & … & {a}_{88}\end{matrix} \vert ,$$

the average value aₘ of the values of the pixels is

$$( {a}_{11} + … {a}_{18} + … {a}_{81} + … {a}_{88} ) / 64 , M = \vert \begin{matrix}{a}_{11} - {a}_{m} & … & {a}_{18} - {a}_{m} \\ … & … & … \\ {a}_{81} - {a}_{m} & … & {a}_{88} - {a}_{m}\end{matrix} \vert$$

is obtained after processing by the transforming module 304, and the transforming module 304 reshapes M into the first vector, and the first vector may be a row vector or a column vector. For example, the first vector is a 1×64 column vector

$$\vert \begin{matrix}{a}_{11} - {a}_{m} \\ … \\ {a}_{18} - {a}_{m} \\ … \\ {a}_{81} - {a}_{m} \\ … \\ {a}_{88} - {a}_{m}\end{matrix} \vert ;$$

however, this embodiment is not limited thereto.

In some embodiments, the acquiring module 302 inputs the first vector into the trained neural network model, and the first vector obtained by the luma processing unit by down-sampling transformation and the first vector obtained by the chroma processing unit by down-sampling transformation may be inputted to identical or different neural network models, in other words, the luma processing unit and the chroma processing unit may use identical partition methods or different partition methods, such as using a signal flag to indicate whether the luma processing unit and the chroma processing unit use identical partition method. When a value of the flag is 1, different partition methods are used, that is, inputting into different neural network models, and when the flag is 0, identical partition method is used, that is, inputting into identical neural network model, and vice versa; however, this embodiment is not limited thereto.

In some embodiments, the above different neural network models refer to neural network models trained by using different training data, such as a luma neural network model trained by using a luma input component and a chroma neural network model trained by using a chroma input component, but structures of the luma neural network model and the chroma neural network model are similar, and their parameters may be different, which shall be described below with reference to FIG. 4.

FIG. 4 is a schematic diagram of the structure of the neural network model. As shown in FIG. 4, the neural network model successively includes a first fully-connected layer 401, a second fully-connected layer 402, a third fully-connected layer 403 and a fourth fully-connected layer 404; wherein the first fully-connected layer outputs a 1×31 column vector, the second fully-connected layer outputs a 1×32 column vector, the third fully-connected layer outputs a 1×32 column vector, and the fourth fully-connected layer outputs a 1×2 column vector. Activation functions of the first fully-connected layer, the second fully-connected layer and the third fully-connected layer are linear rectification functions (ReLU), and an activation function of the fourth fully-connected layer is sigmoid. After the output of the first fully-connected layer, a quantization parameter QP may be added. The quantization parameter may reflect compression of spatial details, the smaller a value, the finer the quantization, the higher the image quality, the longer the generated code stream. In other words, if the QP value is small, the image details will be preserved, and if the QP value is large, the image details will be lost. A value range of QP in the luma neural network model and a value range of QP in the chroma neural network may be identical or different. For example, the value range is 0-51, and after adding the quantization parameter, the second fully-connected layer outputs a 1×32 column vector. The neural network model is an example only, and this embodiment is not limited thereto.

In some embodiments, the acquiring module 302 acquires an output result of the neural network model, the output result including a partition probability in a horizontal direction and a partition probability in a vertical direction, and a range of the probabilities is [0, 1]; wherein a sum of the partition probability in a horizontal direction and the partition probability in a vertical direction is 1.

In some embodiments, when one of the partition probability in a horizontal direction and the partition probability in a vertical direction is greater than or equal to a threshold, the determining module 303 does not perform partition on the processing unit to be partitioned with a probability in a corresponding direction less than the threshold, and only considers a probability in a corresponding direction greater than or equal to the threshold. For example, when partition probability in a horizontal direction is greater than or equal to the threshold, the partition mode in a vertical direction is not considered, and only the partition mode in a horizontal direction is considered, including binary-tree horizontal partition or ternary tree horizontal partition, and the determining module 303 traverses the binary-tree horizontal partition and the ternary tree horizontal partition, calculates rate-distortion function values to which the coding results under various horizontal partition structures correspond, and selects a horizontal partition structure to which an optimal coding performance corresponds according to the rate-distortion function values; and when partition probability in a vertical direction is greater than or equal to the threshold, the partition mode in a horizontal direction is not considered, and only the partition mode in a vertical direction is considered, including binary-tree vertical partition or ternary tree vertical partition, and the determining module 303 traverses the binary-tree vertical partition and the ternary tree vertical partition, calculates rate-distortion function values to which the coding results under various vertical partition structures correspond, and selects a vertical partition structure to which an optimal coding performance corresponds according to the rate-distortion function values.

In some embodiments, when the partition probability in a horizontal direction and the partition probability in a vertical direction are both less than the threshold, the determining module 303 determines to traverse all kinds of the partition modes for the processing unit to be partitioned, namely, traversing the binary-tree horizontal partition, the ternary tree horizontal partition, the binary tree vertical partition and the ternary tree vertical partition, so as to select an optimal partition mode. Reference may be made to the related art for a particular implementation, which shall not be described herein any further.

In some embodiments, the threshold may be determined as demanded, which may be set to be identical or different for processing units of various sizes, and may be set to be identical or different for the luma component and chroma component; for example, the threshold may be set to be 0.8; however, this embodiment is not limited thereto.

In the embodiment of this disclosure, a finally-determined partition mode is further modified by setting the threshold, thereby improving accuracy of the partition. It should be noted that the embodiment of this disclosure makes reference to the related art in which the partition modes are traversed and the partition mode with an optimal performance is selected therefrom, and if it is identical the mode with the related art, it is referred to as correct partition, otherwise, it is referred to as wrong partition.

In some embodiments, the apparatus may further include (optional, not shown): an executing module configured to partition the processing unit to be partitioned in the partition mode determined by the determining module 303 to obtain the coding units. When the partition probability in a horizontal direction is greater than or equal to the threshold, the executing module partitions the processing unit to be partitioned in the horizontal direction, such as binary-tree horizontal partition or ternary tree horizontal partition; when the partition probability in a vertical direction is greater than or equal to the threshold, the executing module partitions the processing unit to be partitioned in the vertical direction, such as binary-tree vertical partition or ternary tree vertical partition, wherein a leaf node of the binary-tree or the ternary tree is referred to as a coding unit; and when both the partition probability in a horizontal direction and the partition probability in a vertical direction are both less than the threshold, the partitioning module partitions the processing unit to be partitioned in the optimal partition mode selected after traversing by the determining module 303, so as to obtain the coding units. Reference may be made to the related art for details.

Therefore, down-sampling is performed on the processing unit to be partitioned, hence, a neural network may be used to determine a horizontal direction partition probability and a vertical direction partition probability, and the probabilities are compared with the threshold so as to determine a mode of partitioning the processing unit to be partitioned, thereby improving a coding speed, and ensuring coding efficiency.

### Embodiment of a Second Aspect

The embodiment of this disclosure provides an image coding/decoding apparatus. FIG. 5 is a schematic diagram of the image coding/decoding apparatus of the embodiment of this disclosure. As shown in FIG. 5, an image coding/decoding apparatus 500 includes: a partitioning module 501, the coding unit partitioning apparatus 502 as described in the embodiment of the first aspect and a coding/decoding module 503,

the partitioning module 501 being configured to partition an image into a plurality of processing units to be partitioned,

the coding unit partitioning apparatus 502 being configured to, for each processing unit to be partitioned, perform down-sampling on the processing unit to be partitioned to obtain a block to be partitioned of a predetermined size, input a first vector transformed from the block to be partitioned into a trained neural network model to acquire an output result of the neural network model, the output result including a partition probability in a horizontal direction and a partition probability in a vertical direction, perform horizontal partition on the processing unit to be partitioned when the partition probability in a horizontal direction is greater than or equal to a threshold, and perform vertical partition on the processing unit to be partitioned when the partition probability in a vertical direction is greater than or equal to the threshold, so as to obtain coding units,

and the coding/decoding module 503 being configured to perform coding and/or decoding by taking a coding unit obtained by partitioning as a unit.

In some embodiments, the partitioning module 501 partitions frame images into multiple CTUs to obtain the processing units to be partitioned. Optionally, each CTU may be further partitioned into subunits after quad-tree partition is performed once or at least twice so as to obtain the processing units to be partitioned. Reference may be made to the embodiment of the first aspect for details of the processing units to be divided, which shall not be described herein any further.

In some embodiments, the coding unit partitioning apparatus 502 determines partition modes of the processing units to be partitioned, and partitions the processing units according to the determined partition mode to obtain the coding units. Reference may be made to the embodiment of the first aspect for particular implementation, which shall not be described herein any further.

In some embodiments, after the coding units are obtained, the coding/decoding module 503 performs coding and/or decoding in a unit of each coding unit obtained by partitioning. Reference may be made to the related art for a particular method for coding and/or decoding, which is not limited in this embodiment. For example, the coding/decoding module 503 determines reference pixels of each CU, filters the reference pixels, determines prediction modes of each CU, and determines a prediction value of a current CU by using filtered reference pixels in combination with the determined prediction modes, so as to obtain coding/decoding results. Reference may be made to the related art for a method for determining the reference pixels, a method for filtering and a method for determining the prediction value, which shall not be described herein any further.

Therefore, down-sampling is performed on the processing unit to be partitioned, hence, a neural network may be used to determine a horizontal direction partition probability and a vertical direction partition probability, and the probabilities are compared with the threshold so as to determine a mode of partitioning the processing unit to be partitioned, thereby improving a coding speed, and ensuring coding efficiency.

### Embodiment of a Third Aspect

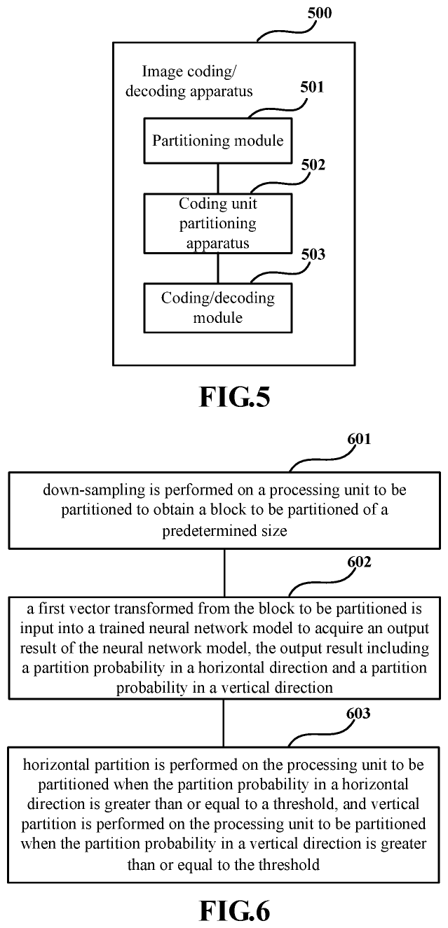

The embodiment of this disclosure provides a code unit partitioning method. FIG. 6 is a schematic diagram of the coding unit partitioning method of the embodiment of this disclosure. As shown in FIG. 6, the method includes:

601: down-sampling is performed on a processing unit to be partitioned to obtain a block to be partitioned of a predetermined size;

602: a first vector transformed from the block to be partitioned is input into a trained neural network model to acquire an output result of the neural network model, the output result including a partition probability in a horizontal direction and a partition probability in a vertical direction; and

603: horizontal partition is performed on the processing unit to be partitioned when the partition probability in a horizontal direction is greater than or equal to a threshold, and vertical partition is performed on the processing unit to be partitioned when the partition probability in a vertical direction is greater than or equal to the threshold.

In this embodiment, reference may be made to the sampling module 301, the acquiring module 302 and the determining module 303 in the embodiment of the first aspect for implementations of the operations 601-603, which shall not be described herein any further.

In some embodiments, a size of the processing unit to be partitioned is less than or equal to 32×32, and a size of the block to be partitioned of the predetermined size is 8×8. Reference may be made to the embodiment of the first aspect for a method for acquiring the processing unit to be partitioned, which shall not be described herein any further.

In some embodiments, an average pooling method is used in 601 for performing down-sampling.

In some embodiments, the method may further include (optional, not shown): the block to be partitioned is transformed into the first vector, including an average value of values of pixels in the block to be partitioned is calculated, and a value of each pixel in the block to be partitioned is subtracted by the average value to obtain the first vector.

In some embodiments, the luma processing unit and the chroma processing unit use identical or different neural network models, and a sum of the partition probability in a horizontal direction and the partition probability in a vertical direction is 1.

In some embodiments, the performing horizontal partition on the processing unit to be partitioned includes binary tree horizontal partition or ternary tree horizontal partition, and the performing vertical partition on the processing units to be partitioned includes binary tree vertical partition or ternary tree vertical partition.

In some embodiments, the method may further include: the processing unit to be partitioned is partitioned according to the determined partition mode to obtain the coding units, and reference may be made to the executing module in the embodiment of the first aspect for implementation thereof, which shall not be described herein any further.

It should be noted that FIG. 6 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 6.

Therefore, down-sampling is performed on the processing unit to be partitioned, hence, a neural network may be used to determine a horizontal direction partition probability and a vertical direction partition probability, and the probabilities are compared with the threshold so as to determine a mode of partitioning the processing unit to be partitioned, thereby improving a coding speed, and ensuring coding efficiency.

### Embodiment of a Fourth Aspect

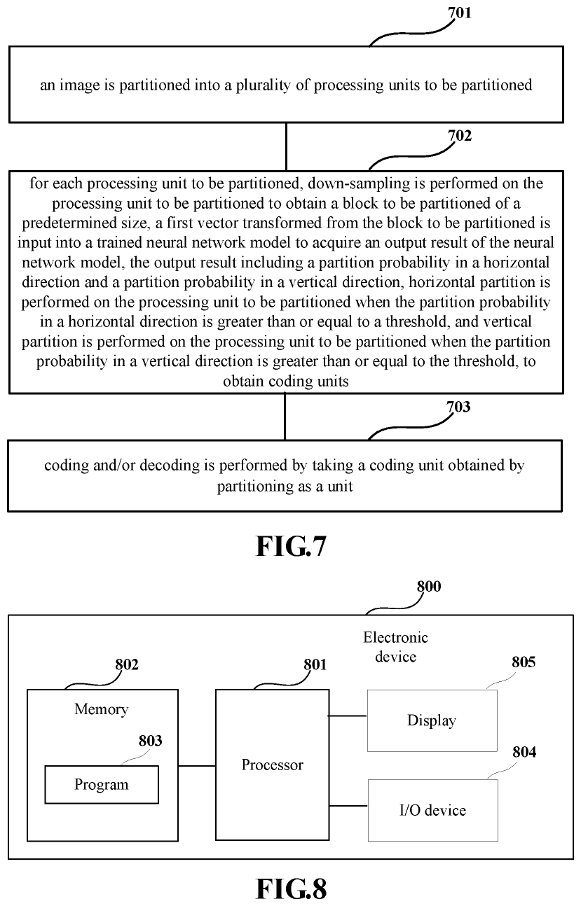

The embodiment of this disclosure provides an image coding/decoding method. FIG. 7 is a schematic diagram of the image coding/decoding method of the embodiment of this disclosure. As shown in FIG. 7, the method includes:

701: an image is partitioned into a plurality of processing units to be partitioned;

702: for each processing unit to be partitioned, down-sampling is performed on the processing unit to be partitioned to obtain a block to be partitioned of a predetermined size, a first vector transformed from the block to be partitioned is input into a trained neural network model to acquire an output result of the neural network model, the output result including a partition probability in a horizontal direction and a partition probability in a vertical direction, horizontal partition is performed on the processing unit to be partitioned when the partition probability in a horizontal direction is greater than or equal to a threshold, and vertical partition is performed on the processing unit to be partitioned when the partition probability in a vertical direction is greater than or equal to the threshold, to obtain coding units; and

703: coding and/or decoding is performed by taking a coding unit obtained by partitioning as a unit.

In this embodiment, reference may be made to the partitioning module 501, the coding unit partitioning apparatus 502 and the coding/decoding module 503 in the embodiment of the second aspect for implementations of operations 701-703, which shall not be described herein any further.

It should be noted that FIG. 7 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 7.

Therefore, down-sampling is performed on the processing unit to be partitioned, hence, a neural network may be used to determine a horizontal direction partition probability and a vertical direction partition probability, and the probabilities are compared with the threshold so as to determine a mode of partitioning the processing unit to be partitioned, thereby improving a coding speed, and ensuring coding efficiency.

### Embodiment of a Fifth Aspect

The embodiment of this disclosure provides an electronic device. The electronic device performs image processing or video processing, and includes the image coding/decoding apparatus in the embodiment of the second aspect, contents of which being incorporated herein, and being not going to be described herein any further.

FIG. 8 is a schematic diagram of the electronic device of the embodiment of this disclosure. As shown in FIG. 8, an electronic device 800 may include: a processor 801 and a memory 802, the memory 802 being coupled to the processor 801. The memory 802 may store various data; and furthermore, it may store a program 803 for information processing, and executes the program 803 under control of the processor 801.

In an embodiment, the electronic device 800 may be used as a codec, and the functions of the image coding/decoding apparatus 500 may be integrated into the processor 801. The processor 801 may be configured to carry out the coding unit partitioning method described in the third aspect or carry out the image coding/decoding method described in the fourth aspect.

For example, the processor 801 may be configured to perform the following control: performing down-sampling on a processing unit to be partitioned to obtain a block to be partitioned of a predetermined size; inputting a first vector transformed from the block to be partitioned into a trained neural network model to acquire an output result of the neural network model, the output result including a partition probability in a horizontal direction and a partition probability in a vertical direction; and performing horizontal partition on the processing unit to be partitioned when the partition probability in a horizontal direction is greater than or equal to a threshold, and performing vertical partition on the processing unit to be partitioned when the partition probability in a vertical direction is greater than or equal to the threshold.

Or, the processor 801 may be configured to perform the following control: partitioning an image into a plurality of processing units to be partitioned; for each processing unit to be partitioned, performing down-sampling on the processing unit to be partitioned to obtain a block to be partitioned of a predetermined size, inputting a first vector transformed from the block to be partitioned into a trained neural network model to acquire an output result of the neural network model, the output result including a partition probability in a horizontal direction and a partition probability in a vertical direction, perform horizontal partition on the processing unit to be partitioned when the partition probability in a horizontal direction is greater than or equal to a threshold, and perform vertical partition on the processing unit to be partitioned when the partition probability in a vertical direction is greater than or equal to the threshold, so as to obtain coding units; and performing coding and/or decoding by taking a coding unit obtained by partitioning as a unit.

Furthermore, as shown in FIG. 8, the electronic device 800 may include: an input/out (I/O) device 804, and a display 805, etc.; wherein functions of the above components are similar to those of the related art, and shall not be described herein any further. It should be noted that the electronic device 800 does not necessarily include all the components shown in FIG. 8; and furthermore, the electronic device 800 may include components not shown in FIG. 8, and reference may be made to the related art.

An embodiment of this disclosure provides a computer readable program, which, when executed in an image coding/decoding apparatus or an electronic device, will cause the image coding/decoding apparatus or the electronic device to carry out the image coding/decoding method as described in the embodiment of the fourth aspect.

An embodiment of this disclosure provides a computer storage medium, including a computer readable program, which will cause an image coding/decoding apparatus or an electronic device to carry out the image coding/decoding method as described in the embodiment of the fourth aspect.

An embodiment of this disclosure provides a computer readable program, which, when executed in a coding unit partitioning apparatus or an electronic device, will cause the coding unit partitioning apparatus or the electronic device to carry out the coding unit partitioning method as described in the embodiment of the third aspect.

An embodiment of this disclosure provides a computer storage medium, including a computer readable program, which will cause a coding unit partitioning apparatus or an electronic device to carry out the coding unit partitioning method as described in the embodiment of the third aspect.

The above apparatus, device and method of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. The present invention also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The software modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments.

However, it should be understood by those skilled in the art that such a description is illustrative only, and not intended to limit the protection scope of the present invention. Various variants and modifications may be made by those skilled in the art according to the principle of the present invention, and such variants and modifications fall within the scope of the present invention.

As to implementations containing the above embodiments, following supplements are further disclosed.

1. A coding unit partitioning apparatus, characterized in that the apparatus includes: a sampling module configured to perform down-sampling on a processing unit to be partitioned to obtain a block to be partitioned of a predetermined size; an acquiring module configured to input a first vector transformed from the block to be partitioned into a trained neural network model to acquire an output result of the neural network model, the output result including a partition probability in a horizontal direction and a partition probability in a vertical direction; and a determining module configured to perform horizontal partition on the processing unit to be partitioned when the partition probability in a horizontal direction is greater than or equal to a threshold, and perform vertical partition on the processing unit to be partitioned when the partition probability in a vertical direction is greater than or equal to the threshold.

2. The apparatus according to supplement 1, wherein a size of the processing unit to be partitioned is less than or equal to 32×32.

3. The apparatus according to supplement 1, wherein a size of the block to be partitioned of a predetermined size is 8×8.

4. The apparatus according to supplement 1, wherein the sampling module performs down-sampling by using an average pooling method.

5. The apparatus according to supplement 1, wherein the apparatus further includes: a transforming module configured to transform the block to be partitioned into the first vector; wherein the transforming module calculates an average value of values of pixels in the block to be partitioned, and subtracts a value of each pixel in the block to be partitioned by the average value to obtain the first vector.

6. The apparatus according to supplement 1, wherein the processing unit to be partitioned include a luma processing unit and a chroma processing unit, the luma processing unit and the chroma processing unit using identical or different neural network models.

7. The apparatus according to supplement 1, wherein a sum of the partition probability in a horizontal direction and the partition probability in a vertical direction is 1.

8. The apparatus according to supplement 1, wherein the performing horizontal partition on the processing unit to be partitioned by the determining module includes binary tree horizontal partition or ternary tree horizontal partition, and the performing vertical partition on the processing unit to be partitioned by the determining module includes binary tree vertical partition or ternary tree vertical partition.

9. A coding unit partitioning method, characterized in that the method includes: performing down-sampling on a processing unit to be partitioned to obtain a block to be partitioned of a predetermined size; inputting a first vector transformed from the block to be partitioned into a trained neural network model to acquire an output result of the neural network model, the output result including a partition probability in a horizontal direction and a partition probability in a vertical direction; and performing horizontal partition on the processing unit to be partitioned when the partition probability in a horizontal direction is greater than or equal to a threshold, and performing vertical partition on the processing unit to be partitioned when the partition probability in a vertical direction is greater than or equal to the threshold.

10. The method according to supplement 9, wherein a size of the processing unit to be partitioned is less than or equal to 32×32.

11. The method according to supplement 9, wherein a size of the block to be partitioned of a predetermined size is 8×8.

12. The method according to supplement 9, wherein the performing down-sampling on the processing unit to be partitioned includes: performing down-sampling by using an average pooling method.

13. The method according to supplement 9, wherein the method further includes: transforming the block to be partitioned into the first vector, including: calculating an average value of values of pixels in the block to be partitioned, and subtracting a value of each pixel in the block to be partitioned by the average value to obtain the first vector.

14. The method according to supplement 9, wherein the processing unit to be partitioned includes a luma processing unit and a chroma processing unit, the luma processing unit and the chroma processing unit using identical or different neural network models.

15. The method according to supplement 9, wherein a sum of the partition probability in a horizontal direction and the partition probability in a vertical direction is 1.

16. The method according to supplement 9, wherein the performing horizontal partition on the processing unit to be partitioned includes binary tree horizontal partition or ternary tree horizontal partition, and the performing vertical partition on the processing unit to be partitioned includes binary tree vertical partition or ternary tree vertical partition.

17. An image coding/decoding apparatus, including a partitioning module, the coding unit partitioning apparatus as described in supplement 1 and a coding/decoding module, the partitioning module being configured to partition an image into a plurality of processing units to be partitioned, the coding unit partitioning apparatus being configured to, for each processing unit to be partitioned, perform down-sampling on the processing unit to be partitioned to obtain a block to be partitioned of a predetermined size, input a first vector obtained transformed from the block to be partitioned into a trained neural network model to acquire an output result of the neural network model, the output result including a partition probability in a horizontal direction and a partition probability in a vertical direction, perform horizontal partition on the processing unit to be partitioned when the partition probability in a horizontal direction is greater than or equal to a threshold, and perform vertical partition on the processing unit to be partitioned when the partition probability in a vertical direction is greater than or equal to the threshold, to obtain coding units, and the coding/decoding module being configured to perform coding and/or decoding by taking a coding unit obtained by partitioning as a unit.

18. The apparatus according to supplement 17, wherein the coding unit partitioning apparatus performs down-sampling by using an average pooling method.

19. The apparatus according to supplement 17, wherein a sum of the partition probability in a horizontal direction and the partition probability in a vertical direction is 1.

20. The method according to supplement 17, wherein the performing horizontal partition on the processing unit to be partitioned includes binary tree horizontal partition or ternary tree horizontal partition, and the performing vertical partition on the processing unit to be partitioned includes binary tree vertical partition or ternary tree vertical partition.

1. An apparatus, comprising:
a memory to store a plurality of instructions; and
a processor coupled to the memory and configured to execute the instructions to:
perform a down-sampling on a processing unit to be partitioned to obtain a block to be partitioned of a predetermined size;
input a first vector transformed from the block to be partitioned into a trained neural network model to acquire an output result of the trained neural network model, the output result including a partition probability in a horizontal direction and a partition probability in a vertical direction; and
perform a horizontal partition on the processing unit to be partitioned when the partition probability in the horizontal direction is greater than or equal to a threshold, and perform a vertical partition on the processing unit to be partitioned when the partition probability in the vertical direction is greater than or equal to the threshold.

2. The apparatus according to claim 1, wherein a size of the processing unit to be partitioned is less than or equal to 32×32.

3. The apparatus according to claim 1, wherein a size of the block to be partitioned of a predetermined size is 8×8.

4. The apparatus according to claim 1, wherein the down-sampling is by using an average pooling method.

5. The apparatus according to claim 1, wherein the processor is further to:
transform the block to be partitioned into the first vector;
wherein the transforming is to calculate an average value of values of pixels in the block to be partitioned, and subtract a value of a pixel, among the pixels, in the block to be partitioned by the average value to obtain the first vector.

6. The apparatus according to claim 1, wherein the processing unit to be partitioned include a luma processing unit and a chroma processing unit, the luma processing unit and the chroma processing unit using identical or different trained neural network models.

7. The apparatus according to claim 1, wherein a sum of the partition probability in the horizontal direction and the partition probability in the vertical direction is 1.

8. The apparatus according to claim 1, wherein to perform the horizontal partition on the processing unit to be partitioned, the processor is to perform a binary tree horizontal partition or a ternary tree horizontal partition, and to perform the vertical partition on the processing unit to be partitioned, the processor is to perform a binary tree vertical partition or a ternary tree vertical partition.

9. A coding unit partitioning method by a computer including a processor coupled to a memory, the method by the computer comprises:
by the processor,
performing down-sampling on a processing unit of an image to be partitioned to obtain a block to be partitioned of a predetermined size;
inputting a first vector transformed from the block to be partitioned into a trained neural network model to acquire an output result of the neural network model, the output result including a partition probability in a horizontal direction and a partition probability in a vertical direction; and
performing a horizontal partition on the processing unit to be partitioned when the partition probability in the horizontal direction is greater than or equal to a threshold, and performing a vertical partition on the processing unit to be partitioned when the partition probability in the vertical direction is greater than or equal to the threshold.

10. The method according to claim 9, wherein a size of the processing unit to be partitioned is less than or equal to 32×32.

11. The method according to claim 9, wherein a size of the block to be partitioned of a predetermined size is 8×8.

12. The method according to claim 9, wherein the down-sampling is by using an average pooling method.

13. The method according to claim 9, wherein the method further includes:
transforming the block to be partitioned into the first vector, the transforming including:
calculating an average value of values of pixels in the block to be partitioned, and
subtracting a value of a pixel, among the pixels, in the block to be partitioned by the average value to obtain the first vector.

14. The method according to claim 9, wherein the processing unit to be partitioned includes a luma processing unit and a chroma processing unit, the luma processing unit and the chroma processing unit using identical or different neural network models.

15. The method according to claim 9, wherein a sum of the partition probability in a horizontal direction and the partition probability in the vertical direction is 1.

16. The method according to claim 9, wherein the performing of the horizontal partition on the processing unit includes a binary tree horizontal partition or a ternary tree horizontal partition, and the performing of the vertical partition on the processing unit to be partitioned includes binary tree a vertical partition or a ternary tree vertical partition.

17. An image coding/decoding apparatus, comprising:
a processor to implement a partitioning module to partition an image, the apparatus as described in claim 1 to perform a coding unit partitioning to obtain coding units, and a coding/decoding module,
the partitioning module being configured to partition the image into a plurality of processing units to be partitioned,
the apparatus being configured to, for a processing unit, among the plurality of processing units, to be partitioned,
perform a down-sampling on the processing unit to be partitioned to obtain a block to be partitioned of a predetermined size,
input a first vector transformed from the block to be partitioned into a trained neural network model to acquire an output result of the trained neural network model, the output result including a partition probability in a horizontal direction and a partition probability in a vertical direction, and perform a horizontal partition on the processing unit to be partitioned when the partition probability in a horizontal direction is greater than or equal to a threshold, and
perform a vertical partition on the processing unit to be partitioned when the partition probability in a vertical direction is greater than or equal to the threshold, to obtain the coding units, and
the coding/decoding module being configured to perform coding and/or decoding by taking a coding unit, among the coding units, obtained by the coding unit partitioning as a unit.

18. The apparatus according to claim 17, wherein the apparatus performs the down-sampling by using an average pooling method.

19. The apparatus according to claim 17, wherein a sum of the partition probability in the horizontal direction and the partition probability in the vertical direction is 1.

20. The method according to claim 17, wherein the performing of the horizontal partition on the processing unit to be partitioned includes a binary tree horizontal partition or a ternary tree horizontal partition, and the performing of the vertical partition on the processing unit to be partitioned includes a binary tree vertical partition or a ternary tree vertical partition.
